(19) United States
(12) Patent Application Publication
(10) Pub. No.: US 2005/0197904 A1
(43) Pub. Date: Sep. 8, 2005

(54) Credit card reward program

(76) Inventors: Claudia A. Baron, New York, NY (US); Yana Bulva, New York, NY (US); Belinda Lang, New York, NY (US); Eileen McMahon, Brooklyn, NY (US); Patricia A. Mee, New York, NY (US); Julia Menichilli, Manhasset, NY (US); William O. Rauschenbach, Chester, NY (US); Eva Reda, Glen Ridge, NJ (US)

Correspondence Address: MCDERMOTT, WILL & EMERY LLP, 227 WEST MONROE STREET, CHICAGO, IL, 60606-5096, US

(21) Appl. No.: 11/053,394

(22) Filed: Feb. 7, 2005

Related U.S. Application Data
(60) Provisional application No. 60/551,151, filed on Mar. 8, 2004.
(60) Provisional application No. 60/604,926, filed on Aug. 27, 2004.

(51) Int. Cl. G06F 17/60

(52) U.S. Cl. 705/14

(57) ABSTRACT

An incentive program system and process for redeeming incentive program points. The system or process may be accomplished through a computer readable medium bearing instructions for administering the incentive program account. The system includes a database for storing points associated with a first incentive program account and a processor that, in response to a program participant's instructions, redeems a number of the points as either a discount for a transaction or for points in a second incentive program account. The process includes storing points associated with a first incentive program account; identifying either transactions available for the redemption of an incentive program discounter a second incentive program account to which said one or more points may be transferred; and either applying a discount to one or more of the transactions available for the redemption of an incentive program discount or transferring points to the second incentive program account.

### CROSS-REFERENCE TO RELATED APPLICATIONS

The present application claims the benefit of U.S. Provisional Application Ser. No. 60/551,151 filed Mar. 8, 2004 and U.S. Provisional Application Ser. No. 60/604,926 filed Aug. 27, 2004, the entirety of each is entirely incorporated herein by reference.

### TECHNICAL FIELD

The present subject matter relates to an incentive program, such as a credit card reward program, for allowing credit card holders to earn and redeem points associated with the card. More specifically, the present subject matter relates to an incentive program whereby a participant can redeem points for varying levels of discounts on goods or services, such as airline tickets, or convert points into airline miles or other non-monetary benefits.

### BACKGROUND

Various credit card issuers offer card holders an opportunity to earn and accumulate points in one form or another in various programs known as reward, loyalty or incentive programs. The accumulated points may sometimes be referred to as “miles” for example with credit cards that allow a card holder to redeem the points (or miles) for free airline tickets. Typically a card holder earns a certain number of points (or miles) for each dollar spent using the credit card. For example, if a card holder purchases goods or services for $100, they may earn 100 points (or miles). The amount of points (or miles) earned per dollar spent can vary and does not need to be 1 point for each dollar spent.

Points (or miles) can be redeemed by card holders for free goods and services, such as airline tickets. In known point redemption programs, a card holder must accumulate a certain number of points (or miles), e.g., 25,000, before the points (or miles) can be redeemed for a free ticket. Higher thresholds of points (or miles) (e.g. 35,000, 50,000) may be set for a user to redeem their points for different types of tickets, e.g., international, first-class, etc. Of course, some products' points can be redeemed for a variety of other goods and services in a similar manner (for example hotels and car rentals). These card products tend to be targeted toward customers who are frequent flyers and can earn points at an accelerated pace.

A drawback of current point redemption programs is that if a card holder has not accumulated the high threshold of points (or miles) needed to redeem them to obtain a particular good or service (e.g. 25,000) for free, the card holder cannot use their points (or miles) toward that item. Accordingly, some consumers do not use their card enough or have enough activity with the corresponding loyalty program to make the point program worthwhile.

Another drawback of current programs is that restrictions are often placed on the ability for a card holder to redeem their points for certain goods or services. For example, points (or miles) cannot be redeemed for airline tickets or hotel reservations during certain peak travel seasons. In addition, the number of seats on a flight or rooms available to be purchased using points (or miles) are strictly limited by inventory controls, and once the limited number of points-based seats or rooms are purchased by other card holders using points (or miles), no more are available.

Thus, there is a need to provide a more flexible program that allows card holders to redeem lower thresholds of accumulated points (or miles) toward the discounted purchase of certain goods or services, which may be only a portion of the total number of points required to otherwise obtain the free good or service. There is also a need to provide a credit card reward program that meets the needs of leisure travelers and those that travel and use a credit card less frequently. There is additionally a customer need to reduce or eliminate restrictions on redeeming points for goods and services.

### SUMMARY

There is provided an incentive program, system and process for redeeming incentive program points. The system or process may be accomplished through a computer readable medium bearing instructions for administering the incentive program account. The system includes a database for storing points associated with a first incentive program account and a processor that, in response to a program participant's instructions, redeems a number of the points as either a discount for a transaction or for points in a second incentive program account. The process includes storing points associated with a first incentive program account; identifying either transactions available for the redemption of an incentive program discount or a second incentive program account to which said one or more points may be transferred; and either applying a discount to one or more of the transactions available for the redemption of an incentive program discount or transferring points to the second incentive program account.

The participant may earn one point for each dollar spent in the incentive program. Depending upon the structure of the inventive program, the points accumulated by the participant can be redeemed for discounts toward the purchase of goods or services or, alternatively, may be converted into points or frequent flier miles in the second incentive program account. For example, if a free airline ticket can be obtained for 25,000 points, the participant may redeem only 2,500 points and receive a 10% discount from the price of the ticket. Similarly, 6,250 points may be redeemed for a 25% discount, 12,500 points may be redeemed for a 50% discount and 25,000 points may be redeemed for a free ticket. The discount provided may instead be a fixed value, rather than a percentage of a transaction. For example, each 7,500 points redeemed may equal a $100 discount. Thus, redeeming 22,500 points would provide a $300 discount. Again, depending upon the structure of the incentive program, discounts may be applied to airline tickets as well as other travel related purchases. Alternatively, a participant may convert accumulated points from the incentive program account into points or frequent flier miles held in the second incentive program account, such as a frequent flyer account provided by an airline company.

### BRIEF DESCRIPTION OF THE DRAWINGS

FIG. 1 is a flow chart illustrating an incentive program process.

FIG. 2 is a conversion chart for determining a percentage discount for a given number of points redeemed.

FIG. 3 is a conversion chart for determining a fixed value discount for a given number of points redeemed.

FIG. 4 is a schematic of an incentive program system.

### DETAILED DESCRIPTION

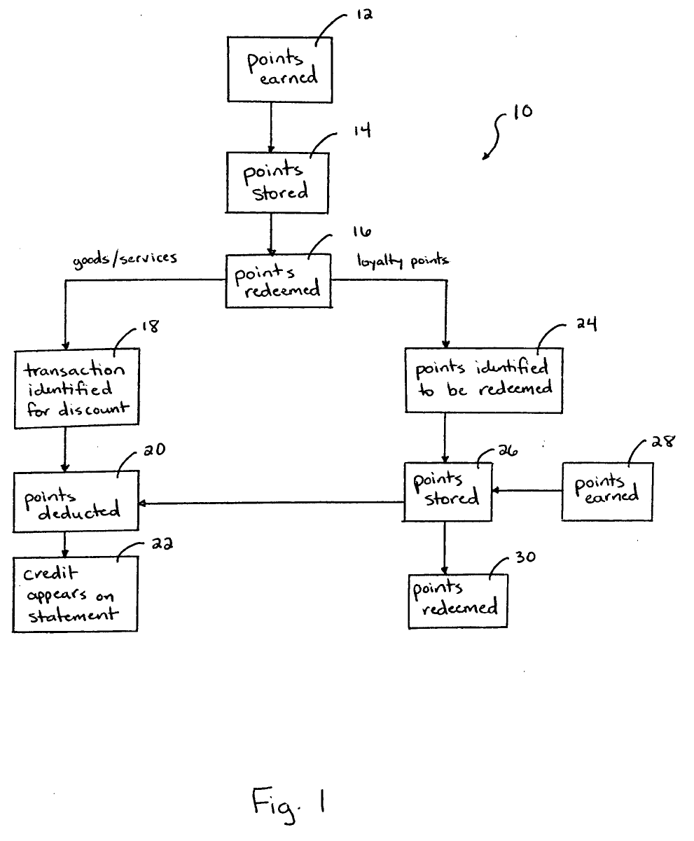

There is provided an incentive program system and process for redeeming incentive program points. The incentive program described herein with respect to FIGS. 1-4 is a transaction card incentive program whereby points are earned for purchases made by a participant cardholder. However, it is understood that the incentive program may be any customer loyalty or incentive program.

As shown in FIG. 1, the process of redeeming incentive program points 10, referred to herein as the process 10, includes step 12 wherein a participant cardholder earns points in a first incentive program. For example, the participant cardholder may earn points for transactions made using the transaction card corresponding to the first incentive program. The participant cardholder may, for example, earn one point for each dollar spent using the transaction card. The points earned by the participant cardholder are not required to correspond in a one-to-one relationship to the dollar amount spent by the participant cardholder. In fact, any ratio of dollar amount spent to points earned may be utilized in the process 10.

As further shown in FIG. 1, the points earned by the participant cardholder in the first incentive program are stored in a database in step 14. The database may be administered by the transaction card issuer. Alternatively, the database may be administered by an incentive program administrator or other third party administrator. The database may also store data corresponding to the transactions related to the participant cardholders account or may be associated with a second database storing such information. For example, the database for storing the participant cardholder's incentive program points may also store the account transaction data including, for example: the date and time of the transaction; information about the vendor, including the industry code specifying the type of transaction made by the participant cardholder; the amount of the transaction; and other relevant transaction information.

As shown in FIG. 1, the stored points may be selected to be redeemed by the participant either for discounts on goods and/or services or for loyalty points in a second incentive program in step 16. The second incentive program may be any incentive program, such as, for example, a frequent flier mileage account administered by an airline company. As illustrated in FIG. 1, if the participant chooses to redeem the stored points for discounts on goods and/or services, the participant identifies one or more transactions to which to apply the discounts in step 18. The participant contacts the database administrator to identify one or more purchases against which points are to be redeemed for a discount in step 26. The account administrator deducts the points selected by the participant to be redeemed from the point total stored in the first incentive program database in step 20. The corresponding credit to the participant's account and the deduction from the stored points then appears on the participant's account statement or other notification via step 22, as further shown in FIG. 1.

As further illustrated in FIG. 1, if the participant chooses to redeem the stored points for loyalty points in the second incentive program, the participant contacts the database administrator to identify a quantity of points to be redeemed for loyalty points in the second incentive program 24. The first incentive program points may be redeemed for second incentive program points at any conversion ratio, as determined by the incentive programs. The second incentive program points are then stored in a second incentive program database through step 26. The second incentive program database may also store second incentive program points, which are earned through step 28. For example, the second inventive program may be an airline frequent flyer program wherein the participant earns points in the second incentive program in step 28 by purchasing airline flights subject to the rules of the second incentive program. As a result, the second incentive program database may store a combination of points earned directly from the second incentive program, as well as points redeemed from the first incentive program. Accordingly, the points stored in the second incentive program database may be redeemed according to the rules of the second incentive program via step 30, as shown in FIG. 1.

As further shown in FIG. 1, when the first incentive program points are redeemed for second incentive program points, the first incentive program account administrator deducts the redeemed points from the point total stored in the first incentive program database in step 20, as described above with reference to redemption of points for goods and/or services. Accordingly, the corresponding deduction of the stored points then appears on the participant's account statement or other notification via step 22, as further shown in FIG. 1.

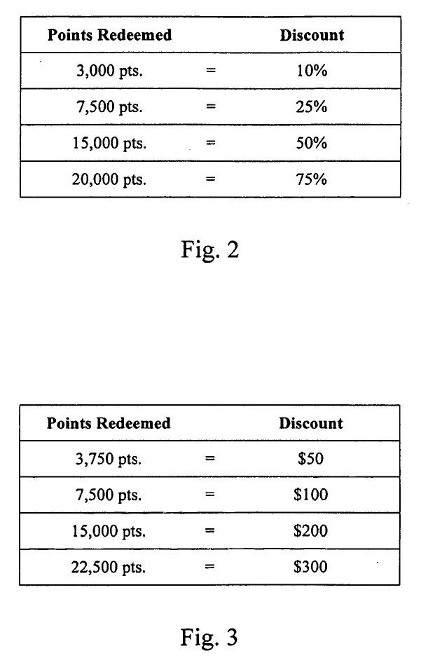

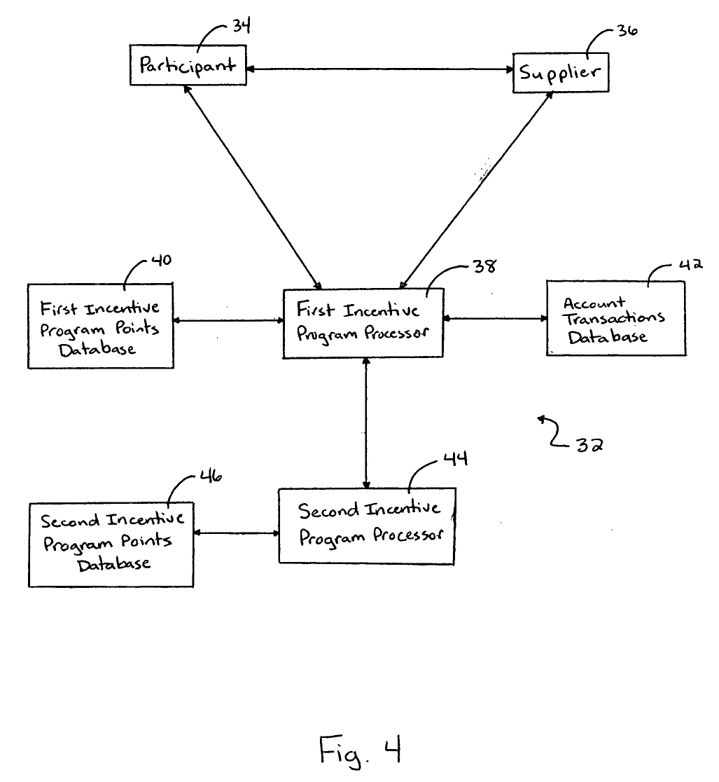

FIG. 2 is a chart illustrating a conversion system for the redemption of points from the first incentive program. For example, if the participant redeems 7,500 points for discounts on goods and services in step 16, the participant may receive a 25% discount on the purchase of those goods and services. Alternatively, FIG. 3 illustrates a conversion system wherein 7,500 points may be redeemed for a $100 discount on the goods and services purchased. FIGS. 2 and 3 are merely examples of conversion charts that may be employed for the redemption of points in the first incentive program. It is contemplated that any other conversion system may be employed as part of the process 10.

FIG. 4 illustrates an incentive program system for redeeming incentive program points 32, referred to herein as the system 32. As shown in FIG. 4, the system 32 includes a participant 34, a supplier 36, a first incentive program processor 38, a first incentive program points database 40, an account transactions database 42, a second incentive program processor 44 and a second incentive program points database 46. The system 32 may be adapted to accomplish the method 10 described herein with respect to FIG. 1. While the system 32 is described herein with reference to FIG. 4, it is understood that the system 32 may be accomplished using any of a plurality of other configurations of processors and databases.

As shown in FIG. 4, the first incentive program processor 38 is adapted to receive instructions from the participant 34, such as the instructions provided by the participant 34 described with respect to steps 16, 18 and 24. The first incentive program processor 38 is further adapted to manage the accumulation and redemption of the first incentive program points in the first incentive program points database 40, such as, for example, to store points as described with respect to step 14 and to deduct points as described with respect to step 20. The first incentive program processor 38 may also be adapted to manage data stored in the account transaction database 42, such as, for example, to identify goods and/or services for which a discount may be applied. The first incentive program processor 38 may be further adapted to receive information from the supplier 36, such as, for example, information about transactions in which the participant 34 earns points. Further, the first incentive program processor 38 may be adapted to communicate with the second incentive program processor 44, which in turn manages points stored in the second incentive program points database 46.

The system 32 or process 10 may be accomplished through a computer readable medium bearing instructions for administering the incentive program account.

An example of a purchase to which a discount may be applied through the process 10 or system 32 described herein is the purchase of an airline ticket. However, discounts may be applied to goods and services within a specific industry, for example, such as other travel related goods and services as well, such as, for example, hotels and rental cars, or any other type of goods or services with or without industry specific limitations. When used to purchase an airline ticket, for example, the discount may be provided off of the lowest price for a ticket. Further, when providing percentage discounts on goods or services, it may be beneficial to limit the maximum discount percentage for a single purchase or purchase period. For example, the maximum discount on an airline ticket purchase may be capped at 75%. Thus, under this example of such a rebate structure, points could not be redeemed for a free purchase. Limits may be placed on the percentage discount, as well as the actual dollar amount discounted. Similarly, limits may be imposed on the amount of discount that can be redeemed within a billing cycle or any other time period.

In one embodiment of the process 10 and/or system 32 of the described loyalty program, the participant 34 may make a purchase for which accumulated points may be redeemed for a discount. The participant 34 then waits for the purchase to appear on the billing statement. The participant 34 may then contact the account administrator, such as, for example, using the Internet, to redeem the desired number of accumulated points. The discount will be credited to the participant's account and the credit will appear on the following account statement. The redemption of loyalty points for a given transaction may be limited to a specific timeframe. For example, the loyalty points may be required to be redeemed within sixty days of the original transaction in order to receive a discount for the purchase.

When the participant 34 contacts the account administrator, as described above, the participant may be provided with a loyalty point account statement, such as, for example, a statement displayed through the Internet, which informs the participant of the accumulated points available for redemption and the transactions to which a discount may be applied.

Alternatively, the redemption of accumulated points may be applied directly towards the purchase of the goods and service described above. For example, travel related purchases made using a transaction card are identified using industry codes associated with the transaction. Accordingly, a travel related purchase made using a transaction card can be identified using these industry codes. Thus, a participant may apply the discounts, whether percentage discounts or dollar value discounts, directly towards the purchase of travel related goods and services using the present system. As a result, the participant's transaction card statement may identify both the standard cost of the travel related purchases made, as well as identify the discount or discounts applied to those purchases. The use of the industry codes and the application of the discounts to various travel related purchases provide a system wherein a participant may enjoy the benefits of the discounts without having to engage in the additional steps of pre-clearing the use of the accumulated points for a given transaction or having to pay the full price for the goods and services before receiving a rebate at a future date or in a future billing cycle.

Those of ordinary skill in the art will readily recognize that many of the functions and aspects of the process 10 and the system 32 can be implemented on networked computers, which may be connected for data communication via components of a network. The hardware of such computer platforms typically is general purpose in nature, albeit with an appropriate network connection for communication via the intranet, the Internet and/or other data networks

As known in the data processing and communications arts, each such general-purpose computer typically comprises a central processor, an internal communication bus, various types of memory (RAM, ROM, EEPROM, cache memory, etc.), disk drives or other code and data storage systems, and one or more network interface cards or ports for communication purposes. The computer system also may be coupled to a display and one or more user input devices such as alphanumeric and other keys of a keyboard, a mouse, a trackball, etc. The display and user input element(s) together form a service-related user interface, for interactive control of the operation of the computer system. These user interface elements may be locally coupled to the computer system, for example in a workstation configuration, or the user interface elements may be remote from the computer and communicate therewith via a network. The elements of such a general-purpose computer system also may be combined with or built into routing elements or nodes of the network..

The software functionalities (e.g., many of the operations described above) involve programming of controllers, including executable code as well as associated stored data. The software code is executable by the general-purpose computer that functions as the particular computer. In operation, the executable program code and possibly the associated data are stored within the general-purpose computer platform. At other times, however, the software may be stored at other locations and/or transported for loading into the appropriate general-purpose computer system. Hence, the embodiments involve one or more software products in the form of one or more modules of code carried by at least one machine-readable medium. Execution of such code by a processor of the computer platform enables the platform to implement the system or platform functions, in essentially the manner performed in the embodiments discussed and illustrated herein.

As used herein, terms such as computer, server or machine readable medium refer to any medium that participates in providing instructions to a processor for execution. Such a medium may take many forms, including but not limited to, non-volatile media, volatile media, and transmission media. Non-volatile media include, for example, optical or magnetic disks, such as any of the storage devices in any computer(s). Volatile media include dynamic memory, such as main memory of such a computer platform. Physical transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include, for example: a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what is considered to be the best mode and/or other examples, it is understood that various modifications may be made therein and that the subject matter disclosed herein may be implemented in various forms and examples, and that they may be applied in numerous other applications, combinations and environments, only some of which have been described herein. Those of ordinary skill in that art will recognize that the disclosed aspects may be altered or amended without departing from the true spirit and scope of the subject matter. Therefore, the subject matter is not limited to the specific details, representative devices, exhibits and illustrated examples in this description. It is intended to protect any and all modifications and variations that fall within the true scope of the advantageous concepts disclosed herein.

1. A computer readable medium bearing instructions for administering an incentive program account, the instructions, when executed, being arranged to cause one or more processors to perform the steps of:
storing points associated with a first incentive program account; and
in response to a program participant's instructions, redeeming a number of said points as either a discount for a transaction or for points in a second incentive program account.

2. The computer readable medium of claim 1 wherein said points are redeemed for a discount of a percentage of the value of a transaction.

3. The computer readable medium of claim 1 wherein said points are redeemed for a fixed value discount.

4. The computer readable medium of claim 1 wherein said second incentive program is a frequent flier program administered by a travel provider.

5. The computer readable medium of claim 1 further performing the step of identifying one or more transactions associated with said first incentive program account to which an incentive program discount may be applied.

6. The computer readable medium of claim 1 further performing the step of reporting to said program participant the disposition of the points redeemed in response to said program participant's instructions.

7. The computer readable medium of claim 6 wherein said reporting is an account statement identifying a transaction and a redeemed discount applied to said transaction.

8. A process of redeeming incentive program points, the processing comprising the steps of:
storing points associated with a first incentive program account;
in response to receiving instructions, identifying either transactions available for the redemption of an incentive program discount or a second incentive program account to which said one or more points may be transferred; and
in response to receiving instructions, either applying a discount to one or more of said transactions available for the redemption of an incentive program discount or transferring points to said second incentive program account.

9. The process of claim 8 wherein said points are redeemed for a discount of a percentage of the value of a transaction.

10. The process of claim 8 wherein said points are redeemed for a fixed value discount

11. The process of claim 8 wherein said second incentive program is a frequent flier program administered by a travel provider.

12. The process of claim 8 further comprising the step of reporting to a program participant the disposition of the points redeemed in response to said instructions.

13. The process of claim 12 wherein said reporting is an account statement identifying a transaction and a redeemed discount applied to said transaction.

14. An incentive program system comprising:
a database for storing points associated with a first incentive program account; and
a processor that, in response to a program participant's instructions, redeems a number of said points as either a discount for a transaction or for points in a second incentive program account.

15. The incentive program of claim 14 wherein said points are redeemed for a discount of a percentage of the value of a transaction.

16. The incentive program of claim 14 wherein said points are redeemed for a fixed value discount.

17. The incentive program of claim 14 wherein said second incentive program is a frequent flier program administered by a travel provider.

18. The incentive program of claim 14 wherein said processor identifies one or more transactions associated with said first incentive program account to which an incentive program discount may be applied.

19. The incentive program of claim 14 wherein said processor reports to said program participant the disposition of the points redeemed in response to said program participant's instructions.

20. The incentive program of claim 19 wherein said report is an account statement identifying a transaction and a redeemed discount applied to said transaction.
